(19) United States
(12) Patent Application Publication
(10) Pub. No.: US 2005/0268736 A1
(43) Pub. Date: Dec. 8, 2005

(54) Mechanical actuator including a helical-cam nut

(75) Inventor: Jean-Pierre Gaechter, Rebigue (FR)

Correspondence Address: EGBERT LAW OFFICES, 412 MAIN STREET, 7TH FLOOR, HOUSTON, TX, 77002, US

(73) Assignee: BUBENDORFF, Saint-Louis (FR)

(21) Appl. No.: 10/524,298

(22) PCT Filed: Aug. 29, 2003
(86) PCT No.: PCT/FR03/02607

§ 371 Date: Jul. 28, 2005

(30) Foreign Application Priority Data
Aug. 29, 2002 (FR) 02/10715

(51) Int. Cl. F16H 25/22

(52) U.S. Cl. 74/89.23; 74/424.73; 74/89.35

(57) ABSTRACT

The actuator includes a first tubular body, a nut positioned inside the tubular body and having at least a globally helical raceway, balls arranged between the raceway and the tubular body (20), and driving mechanisms designed to drive the nut in rotation. The driving mechanism has a motor, the rotating nut driving the tubular body in translation relative to the nut. The motor is mounted fixed inside a second body adapted to be driven in translation relative to the first tubular body.

### RELATED U.S. APPLICATIONS

Not applicable.

### STATEMENT REGARDING FEDERALLY SPONSORED RESEARCH OR DEVELOPMENT

Not applicable.

### REFERENCE TO MICROFICHE APPENDIX

Not applicable.

### FIELD OF THE INVENTION

The invention relates to the field of the mechanical linear actuators and, in particular, of the mechanical actuators driven by an electric motor (electromechanical actuators).

### BACKGROUND OF THE INVENTION

The development of the electromechanical linear actuators is related to the needs in fields such as robotics and home systems. Indeed, in these fields the electromechanical jacks compete with the traditional, hydraulic or pneumatic jacks, because they are more easily controllable, more accurate and do not require an external source of fluid.

These electromechanical actuators generally include a ball screw on which a nut is mounted. The nut is rotated by an external geared motor. The rotation of the nut drives the screw in translation.

The drawback of these electromechanical actuators is that they are relatively cumbersome.

Moreover, since the cost of the ball screws is generally high compared to the other mechanical parts they contain, these actuators remain relatively expensive.

### BRIEF SUMMARY OF THE INVENTION

An object of the invention is to provide a compact actuator structure and the manufacture of which would be simplified compared to the actuator structures of the prior art.

To this end, the invention provides an actuator including a first tubular body, a nut positioned inside the tubular body and having at least a generally helical ball-race, balls arranged between the ball-race and the tubular body, and driving means for rotating the nut, said driving means comprising a motor, the rotation of the nut driving the tubular body in translation with respect to the nut, characterized in that the motor is mounted fixed inside a second body capable of being displaced in translation with respect to the first tubular body.

The fact that the actuator comprises an internal nut allows to position the motor inside a second body. In addition, the re-circulation path can be integrated into the nut. This arrangement leads to a compact actuator structure the external appearance of which is similar to that of the pneumatic actuators. In particular, the actuator does not leave visible any external geared motor device. The actuator provided is thus particularly compact, compared to the effort which it is capable of generating.

In addition, the use of a tubular structure imparts to the actuator a better buckling strength than a traditional actuator having an external nut mounted about an internal screw.

In an implementation of the invention, the balls are fitted between the race and the first tubular body, with a determined radial prestressing.

The fact that the balls are fitted with prestressing allows to obtain a linear actuator capable of transmitting significant efforts, compared to its size.

In an implementation of the invention, the race includes a helical portion extending about the nut according to an angle of less than 360 degrees and a widened portion connecting the adjacent ends of the helical portion, said widened zone constituting a re-circulation zone for the balls.

This implementation has the advantage of not requiring the formation of an internal re-circulation race in the nut. The balls are automatically “recycled” as soon as they reach the re-circulation zone.

In addition, the inner surface of the first tubular body can advantageously have helical ball-races the function of which is to guide the balls. These ball-races reduce the risks of sliding of the balls on the inner surface of the first body when the actuator exerts a significant effort. The widened re-circulation zones allow the passing over of the balls from one ball-race to an adjacent race, over a race edge during their re-circulation.

In a preferred implementation of the invention, the nut includes several aligned elements, of a cylindrical general shape, each having at least a bevel forming a helical cam surface, the bevels forming, two by two, helical ball-races in which balls are positioned. Each element is formed from a cylindrical part with a straight cross-section, one circular edge of which is beveled, in order to form said helical cam surface inclined with respect to the axis of the cylindrical part, the ends of helical surface being joined by a setback surface with a preferably conical general shape.

Each element of the nut is formed from a cylindrical part with a straight cross-section, i.e. the cylindrical part is limited by two parallel planes orthogonal to its axis of rotation. This is a simple shape. The shape of the elements is therefore easier to be generated than in the prior art.

According to the technique for carrying out the bevel, the setback surface can also have a general shape that is convex, concave, planar, cylindrical, planar with conical connection or cylindrical connection or the like.

Advantageously, each helical cam surface forms a setback and two elements are so positioned with respect to each other that their setbacks are in front of each other, said setbacks forming the balls re-circulation zone.

Advantageously, the prestressing exerted on the balls is generated by tightening the elements with respect to each other.

To this end, the actuator can include an element adjusting nut for controlling the prestressing exerted onto the balls.

The effort which can be exerted by the actuator directly depends on the prestressing applied to the balls and adjusted by the adjusting nut.

Advantageously, the actuator includes elastic means interposed between the adjusting nut and the nut elements through which the adjusting nut exerts prestressing on the elements.

Preferably, the motor is an electric or hydraulic motor.

The invention also relates to a nut element aimed at being arranged in an actuator as defined above. The nut element is formed from a cylindrical part with a straight cross-section, one circular edge of which is beveled to form said helical cam surface inclined with respect to the axis of the cylinder, the ends of the helical surface being connected by a setback surface with a conical general shape.

The invention also relates to a process for obtaining a nut element aimed at being arranged in an actuator according to the invention. The process includes the steps consisting in machining a circular edge of a cylindrical part with a straight cross-section, in order to generate a bevel forming a helical cam surface inclined with respect to the axis of the cylinder, the ends of helical surface being connected by a setback surface with a conical general shape.

One understands that the process for obtaining the nut element is easy to be implemented with traditional machining means.

Further characteristics and advantages will clearly appear from the following description, which is purely illustrative and non-restrictive and must be read with reference to the attached figures.

### BRIEF DESCRIPTION OF THE SEVERAL VIEWS OF THE DRAWINGS

FIG. 1 shows a longitudinal cross-sectional view of an example of an actuator structure according to an embodiment of the invention in which the driving means include an electric motor.

FIG. 2 is a diagram representing a prestressed ball,

FIG. 3 is a perspective view of a cam constituting the nut,

FIG. 4 is a diagram representing a step of generating a helical cam surface,

FIG. 5 is a diagram representing the positioning of two cams with respect to each other on the driving shaft of the actuator,

FIG. 6 schematically shows the positioning of two pairs of cams with respect to each other, in which the ball re-circulation zones are regularly distributed around the driving shaft,

FIG. 7 shows an example of inner surface of the tubular body having ball-races formed by a wire wound into a spiral,

FIGS. 8 and 9 schematically show ball-races formed by a first wound wire and a intermediate second wire arranged between the windings of the first wire,

FIG. 10 schematically shows ball-races formed by plastic distortion of an inner tube arranged in the tubular body,

FIG. 11 schematically shows a step of welding of the inner tube in the tubular body,

FIG. 12 shows a longitudinal cross-sectional view of an actuator structure of a telescopic type,

FIG. 13 shows the actuator of FIG. 12 in unfolded position,

FIG. 14 schematically shows the positioning of a ball resting between the nut and a ball-race,

FIG. 15 is a cross-sectional and perspective view of the balls when they arrive in a re-circulation zone,

FIG. 16 is a diagram representing the positioning of two cams with respect to each other.

### DETAILED DESCRIPTION OF THE INVENTION

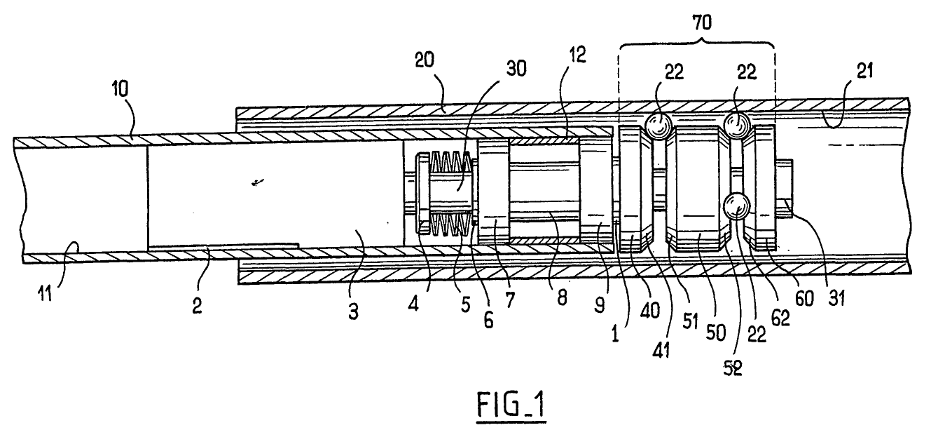

In FIG. 1, the linear actuator includes an inner tube 10 and an outer tube 20 the diameter of which is larger than the diameter of the inner tube 10. The inner tube 10 extends partly in the outer tube. Both tubes 10 and 20 are locked in rotation with respect to each other and are capable of being actuated to slide with respect to each other in their longitudinal direction.

To this end, the actuator includes a drive mechanism including a driving shaft 30 extending according to the longitudinal axis of the tubes 10 and 20. The shaft 30 is rotated by an electric motor 2 fixed at one of its ends and positioned in the inner tube 10. The motor 2 and the shaft 30 are maintained in the inner tube 10 through a cylindrical support 3 fixed to the inner tube.

Furthermore, the shaft 30 is guided in the inner tube 10 through two ball bearings 7 and 9 the inner ring of which is fitted on the shaft 30 and the outer ring rests against the inner surface 11 of the inner tube 10. Both bearings 7 and 9 are maintained at a distance by a spacer 8 in the form of a cylindrical sleeve resting on the inner rings of the bearings 7 and 9 as well as through a spacer 12 pinned in the inner tube 10 and resting on the outer rings of the bearings 7 and 9. The absorption of the axial forces exerted on the bearings can occur either through the spacer 12 or by any other equivalent means (for example circlips locking the bearing).

The shaft 30 supports in addition an adjusting nut 4, a set of Belleville washers 5, a first clamping washer 6 positioned between the support 3 of the motor and the bearing 7. The clamping washer 6 rests on the inner cage of the bearing 7. The shaft 30 also supports a second clamping washer 1 and ball nut 70, positioned between the bearing 9 and a thrust element 31 at the end of the shaft 30.

The nut 70 is formed of a succession of cams 40, 50 and 60 with cylindrical general shapes mounted aligned on the shaft 30 and locked in rotation with respect to the shaft by a key. The cams 40, 50, 60 have helical bevels 41, 51 and 52, 62, oriented at 45° with respect to the axis of the shaft 30. These bevels 41, 51, 52, 62 form, two by two, helical ball-races in which balls 22 are positioned. The balls 22 are into contact, on the one hand, with two surfaces with opposite bevels, 41 and 51, or 52 and 62 and, on the other hand, with the smooth inner surface 21 of the outer tube 20. The radial force applied to the balls 22 is controlled by tightening the nut 4. The adjusting nut 4 applies a compressive force to the Belleville washers 5 according to the longitudinal direction of the shaft 30. This compressive force is transmitted to the cams 40, 50, 60 through the clamping washer 6 which transmits and distributes the clamping force on the inner cages of the bearings 7 and 9 and on the clamping washer 1. The cams 40, 50, 60 are thus in compressed state between the clamping washer 1, the balls 22 and the thrust element 31 at the end of the shaft 30. By tightening the cams 40, 50, 60, the adjusting nut 4 advantageously allows to adjust the prestressing exerted on the balls 22.

The actuator of FIG. 1 includes two ball-races formed by three cams 40, 50 and 60 aligned on the shaft 30. Of course, it is possible to form an actuator having only one ball-race or a number of ball-races higher than two. It is enough to change the number of cams mounted on the shaft, each ball-race being formed between two successive cams.

The force that can be exerted by the actuator of FIG. 1 directly depends on the prestressing applied to the balls and set by the adjusting nut 4.

However, the prestressing force which can be applied to the balls 22 remains limited by the Hertz pressure which the surface of the cams 40, 50, 60 and the inner surface 21 of the outer tube 20 can be subjected to.

When the motor 2 of the actuator of FIG. 1 is operating, it rotates the shaft 30 and, hence, the cams 40, 50 and 60 which are keyed on the latter. The balls 22 then roll between their ball-race and the inner surface of the outer tube. The tangential speed of the center of each ball 22 thus has two components: a tangential component, perpendicular to the axis of rotation of the shaft 30 and a longitudinal component parallel to the axis of the shaft 30 due to the pitch of the helix of the ball-race.

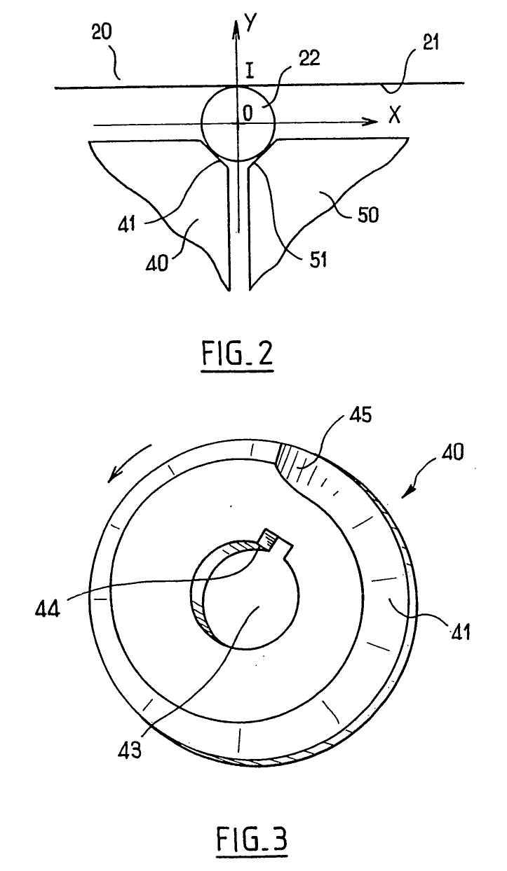

As shown in FIG. 2, a ball 22 turns about an axis inclined with respect to the axis of the shaft 30 according to an angle equivalent to that of the helix of the ball-race. Moreover, the point of contact I between the ball 22 and the inner surface of the tube is always positioned on the line perpendicular to the axis of rotation passing through the point 0. This results into the outer tube 20 being driven in translation at a speed proportional to the speed of rotation of the driving shaft 30 and to the pitch of the helical race.

The linear actuator of FIG. 1 can be mounted by carrying out the following steps:
mounting the various elements on the shaft 30: cams 60, 50, 40, washer 1, bearing 9, spacers 8 and 12, bearing 7, washer 6, Belleville washers 5, adjusting nut 4,
inserting the end of the shaft 30 bearing the cams 40, 50, 60 into the outer tube 20, the balls 22 being positioned in the ball-races,
tightening the nut 4 which causes the nearing of the cams 40, 50, 60 and the prestressing of the balls 22 between surfaces of the bevels and the inner surface 21 of the outer tube 20.

FIG. 3 shows an example of a cam 40 used in the mounting of FIG. 1. The cam 40 has a cylindrical general shape. It includes a central bore 43 aimed at receiving the driving shaft 30, as well as a key slot 44 formed from the bore 43 and aimed at allowing indexing the cam 40 on the shaft 30. A helical bevel 41 has been carried out by milling of a circular edge of the cam 40. This cam is formed from a cylindrical part with a straight cross-section, one circular edge of which is beveled, in order to form said helical cam surface inclined with respect to the axis of the cylindrical part, the ends of helical surface being connected by a setback surface with a conical general shape.

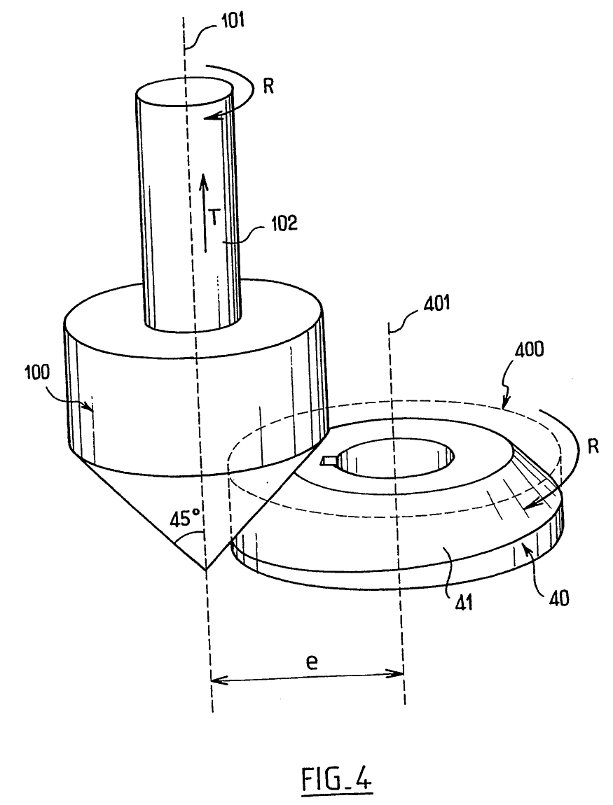

As shown in FIG. 4, the milling operation is carried out using a conical cutter 100 the cutting edges of which form an angle of 45 degrees with respect to its axis of rotation 101. The cutter is mounted on a rotary machining spindle 102. A cylindrical rotation part 400 (shown in dotted lines) aimed at forming the cam 40 is mounted on a rotary table. It is so arranged with respect to the cutter 100 that their axes 101 and 401 are parallel and have a given separation e. The part 400 is subjected during the milling operation to a rotational movement with respect to its axis 401 (indicated by arrow R). Simultaneously, the cutter 100 is subjected to a translational movement (indicated by arrow T) along its axis 101. The translational movement is carried out in a direction in which the cutter 100 moves away from the cylindrical part 400. The part 400 carries out a rotation of 360 degrees, while the spindle 102 is moved in translation by a distance equal to the pitch of the helical bevel to be generated. This milling operation leads to the generation of the helical bevel 41 oriented at 45 degrees with respect to the axis 401.

Traditional heat-treatment and rectifying operations can then be carried out on the helical surface 41 obtained (for example grinding of the helical surface).

As can be seen in FIG. 3, the helical bevel of the cam 40 forms a circumferential surface 41 which widens when it is followed in the opposite direction to the milling and is connected at his ends by a setback with a conical shape 45. This setback with a conical shape is generated by the shape of the conical cutter when starting its initial radial passage in the part 400.

Of course, variants of the above-described embodiment can be contemplated. In particular, the shape of the setback can vary according to the path of the initial passage of the cutter. If the conical cutter penetrates into the part 400 according to a tangential passage start, the setback obtained will have a planar general shape. If the conical cutter penetrates into the part 400 according to an oblique passage start, the setback obtained will have a planar general shape with conical connection.

It is also possible to use a cylindrical cutter the axis of rotation of which would be inclined with respect to the axis of the cylindrical part and according to the path of the start of the initial passage, in order to obtain a setback with a cylindrical, planar or planar general shape with a cylindrical connection.

In addition, when the pitch of the race is large with respect to the diameter of the cams, the helical ball-race must be obtained by a different process. For example, a previous step of milling of the cylindrical part using a cylindrical cutter can be carried out, in order to obtain in the first place a helical surface oriented perpendicularly to the axis of the part. Then, a step of milling of the edge of the helical surface using a conical cutter is carried out, to make a helical bevel oriented at 45 degrees with respect to the axis of the part. The helical bevel thus obtained forms a circumferential surface with a constant width which is connected at its ends by a conical setback.

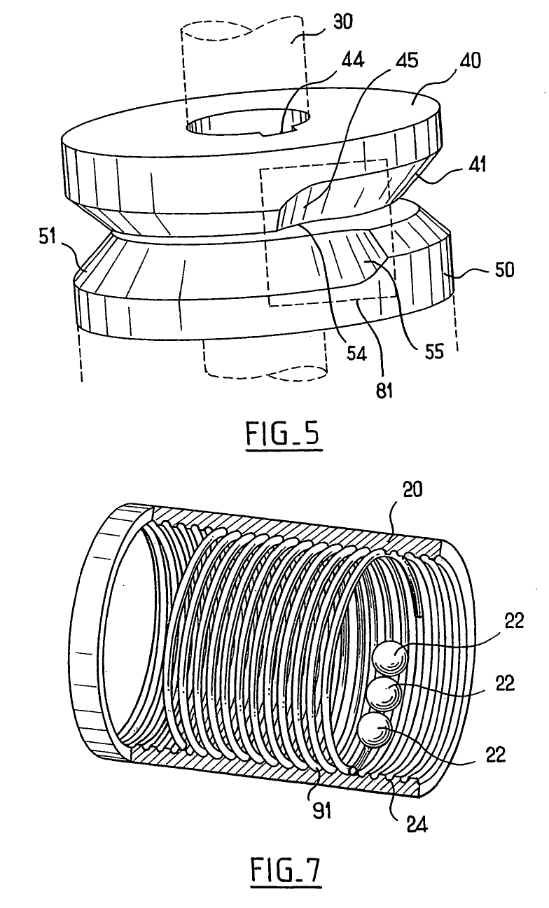

FIG. 5 shows the positioning of two cams 40 and 50 with respect to each other on the driving shaft 30. Both cams 40 and 50 have each an identical beveled surface 41, 51. They are positioned side by side on the driving shaft 30, so that their respective beveled surfaces 41 and 51 are faced to each other, in order to form a helical race for the balls 22. The cams 40 and 50 are each indexed on the shaft 30 by their key slot 44 or 54. The key slots 44 and 54 are so positioned with respect to the bore of the cams 40 and 50 that the conical setback surfaces 45 and 55 of the cams 40 and 50 are positioned in front of each other, in an opposite way, when the latter are mounted on the shaft 30.

The conical setback surfaces 45 and 55 of both cams 40 and 50 advantageously form a widened zone 81 which accommodates the balls 22 and allows their re-circulation. When the shaft 30 of the actuator is rotated, the balls 22 roll on the ball race formed by the beveled surfaces 41 and 51. When a ball 22 arrives in the re-circulation zone 81 where the two beveled surfaces 41 and 51 have a maximum width, it is no longer into contact with the inner surface 21 of the outer tube 20, so that it does no longer roll. The ball 22 remains in the re-circulation zone until it is pushed by the arrival of a next ball and thus automatically re-inserted into the ball-race.

In FIG. 1, the nut 70 formed by the association of the cams 40,50,60 has the advantage of not requiring the formation of an inner re-circulation race. Thus, in this implementation of the invention, the balls 22 are automatically “recycled” as soon as they reach the re-circulation zone 81 connecting the ends of a ball-race.

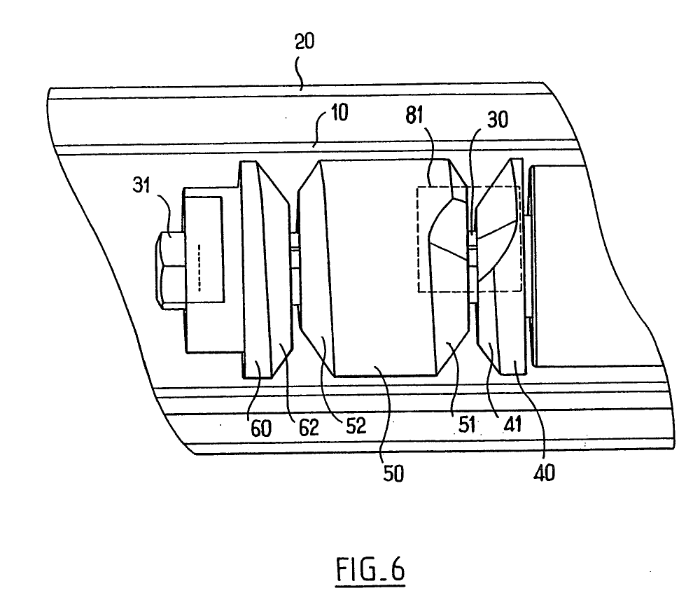

FIG. 6 shows the positioning of the successive cams 40, 50 and 60 with respect to each other on the driving shaft 30. These cams are so arranged that the re-circulation zones of the balls are not aligned. More particularly, the cams are oriented on the driving shaft 30 so that the re-circulation zones are angularly distributed in a regular way about the axis of the shaft 30 (axis of rotation and translation of the actuator). Thus, in FIG. 6, the nut including two ball-races formed by the cams 40, 50 and 50, 60, respectively, it has two re-circulation zones which are arranged at 180 degrees with respect to each other about the axis of the shaft 30.

In the case of a nut including three roll-races which would have three re-circulation zones, the cams would be so oriented that the re-circulation zones are arranged at 120 degrees with respect to each other about the axis of the shaft 30.

In a general way, in the case of a nut including N ball-races (formed by N pairs of cams), the cams would be so oriented that the re-circulation zones are arranged at 360/N degrees with respect to each other about the axis of the shaft 30.

This feature allows to avoid a rotational movement of the inner tube 10 with respect to the outer tube 20 which can occur when the actuator comprises only one pair of cams (i.e. only one ball-race) or when the re-circulation zones are arranged aligned.

In a variant of the linear actuator of FIG. 1, the inner 10 and outer 20 tubes are made out of a relatively light material: for example, out of a composite or plastic material or out of a light alloy. Ball-races can be formed on the inner surface 21 of the outer tube 20. These ball-races allow to reduce the Hertz pressure exerted by the balls 22 on the surface of tube 20. The ball-races are formed by burnishing the inner surface 21 of the tube 20. The ball-races can advantageously be formed by the balls 22 themselves during the rotation of the shaft 30. The balls 22 produce a plastic distortion of the surface 21 while forming ball-races.

In the event the outer tube 20 is made out of a light alloy, after having formed the ball-races, a ceramization treatment for hardening this surface in depth (0.1 to 0.2 mm) is applied to the surface 21 of the tube 20.

The constitution of the ball-races allows to apply compressive forces which a smooth cylindrical surface would not withstand. In addition, these races allow to apparently increase the external friction coefficient between the ball and the tube.

Alternatively, the ball-races allow not to apply too great a prestressing force to the balls. Since the balls are guided by the ball-races, they cannot slide with respect to the outer tubular body 20.

These ball-races have a helical pitch substantially equal to the helical pitch of the ball-race formed in the nut 70.

In this variant, the actuator includes, in combination, ball-races on interior surface 21 of the outer tube 20 and one nut 70 having re-circulation zones in the form of widened spaces. Thanks to this structure, when a ball arrives in a re-circulation zone, it penetrates radially towards the interior of the nut 70, so that it is no longer into contact with one of the races formed in the outer tube 20. Thus, when “recycled”, the ball passes from one ball-race onto an adjacent race, over a race edge, this passing over from one race to another one being possible thanks to the widened space forming the re-circulation zone.

In still another variant of the actuator of FIG. 1, the inner 10 and outer 20 tubes are also made out of a relatively light material. Ball-races are formed on the inner surface of the outer tube 20. As shown in FIG. 7, the ball-races are formed by a high-strength steel wire 91 positioned in a helical way inside the outer tube 20. In such a variant, the balls 22 roll resting on two successive windings of the wire 91. This variant allows to obtain a mechanically positive connection between the balls 22 and the races of the tube 20 (there is no longer any friction, but a support). The longitudinal components of the forces of support on the windings of the wire 91 are positive supports. The inner surface 21 of the outer tube 20 includes a helical groove 24 aimed at receiving the steel wire 91.

This variant allows to use tubes made out of aluminum, KEVLAR©, carbon fibers or molded plastic, which guarantees the lightness of the final actuator structure obtained.

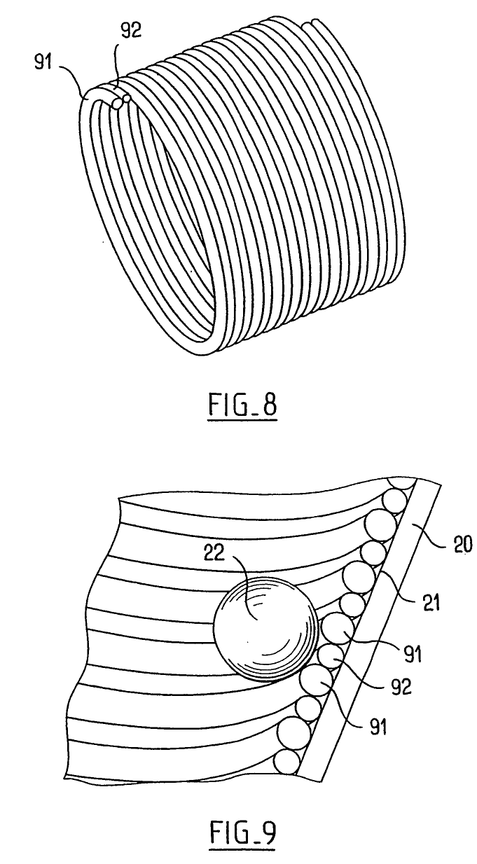

In an implementation shown in FIGS. 8 and 9, the inner surface 21 of the outer tube 20 is smooth. Ball-races are formed on the inner surface of the outer tube 20. They are formed by a first high-strength steel wire 91 positioned in a helical way inside the outer tube 20 and on which the balls 22 rest. A second intercalated wire 92 having a diameter smaller than that of the first wire 91 extends between the windings of the first wire. This second wire 92 maintains the separation between the windings of the first wire. It prevents, in particular, the windings of the first wire 91 from separating during the passing through of a ball 22. In a preferential way, the balls 22 are not into contact with the intermediate wire 92. This implementation is particularly simple and avoids having to use techniques for machining the outer tube 20.

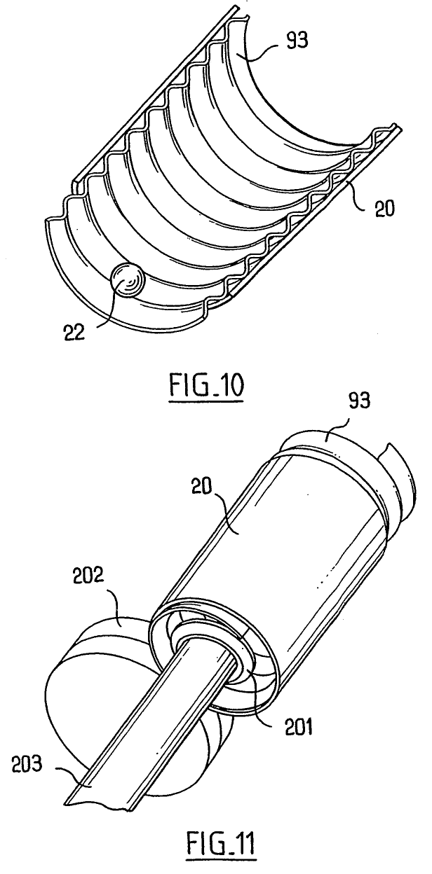

FIG. 10 shows still another variant of the invention in which ball-races are made by plastic distortion in a calibrated inner tube. The inner tube 93 is arranged in the outer tube 20 and welded to the latter.

The ball-races in the inner tube 93 are made as follows. For example, a burnishing or shaping machine is used, which includes a roller holder provided with three rollers arranged at 120 degrees with respect to each other and oriented according to the helix angle of the race to be obtained. The inner tube 93 is fixed on a chuck the shape of which is close to the inner profile to be achieved. The roller holder is rotated. At the same time, the tube 93 and the chuck are driven in translation. The speed of translation of the tube 93 is set so that the translation distance is equal to the pitch of the helix at each turn of the roller holder. The operation can be carried out in one single pass and the tube 93 is then highly cold hardened, which increases the rigidity and the hardness of the surface. Once shaped, the tube 93 is inserted into the outer tube 20.

FIG. 11 shows a step of welding the inner tube 93, in which the ball-races are formed, in the outer tube 20 of the actuator. In order to make both tubes integral with each other, one proceeds to a series of spot welding operations on the bottom of the race between the two tubes. To this end, one uses, for example, a spot welder including an inner thumb wheel 201 mounted on a shaft 203 and a motorized outer thumb wheel 202. The inner thumb wheel is inclined with respect to the shaft 203 according to an angle equal to the helix angle of the ball-races. The welding operations are carried out on the bottom of the helical races into contact with the outer tube 20. The unit thus formed is boxed and the axial distortion of the unit is insignificant. This small distortion guarantees a linearity of the conversion of the rotational movement into a translational movement in the final actuator.

In the event ball-races are formed on the inner surface of the outer tube 20, each cam 40, 50 or 60 has a bevel oriented according to an angle smaller than or equal to 45 degrees with respect to the axis 401 of the cam, preferably strictly smaller than 45 degrees and preferably of about 35 degrees. This feature allows to decrease the radial force which serves as a support for the reaction of the forces applied to the ball-race. Moreover, this feature facilitates the passing of the balls over the edges of the races during their re-circulation. Indeed, the component of the force which allows a ball to pass over a race edge (formed for example by a wire) passes above the edge of the race.

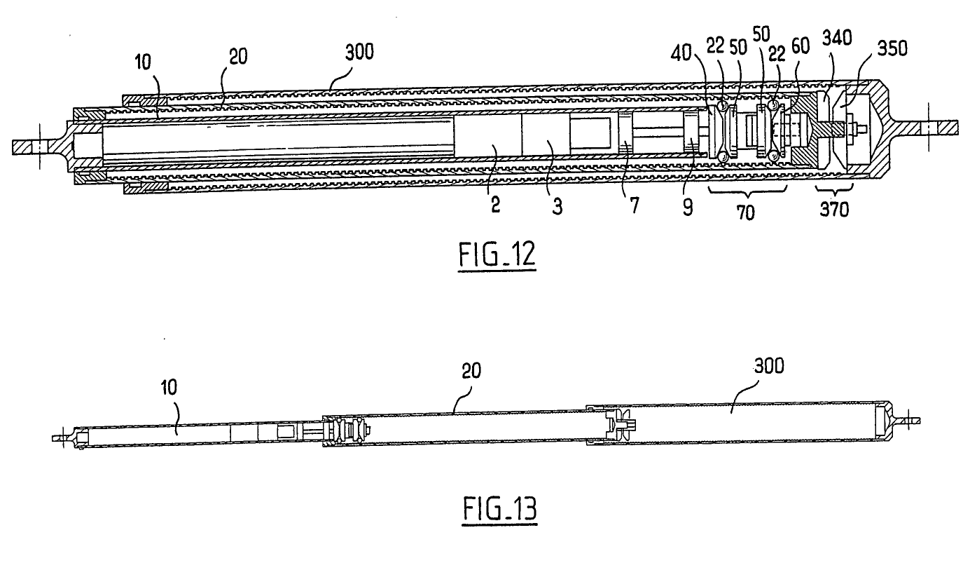

FIG. 12 shows a linear actuator of a telescopic type. This actuator is similar to that of FIG. 1. It includes an inner tube 10 and an outer tube 20 the diameter of which is larger than the diameter of the inner tube 10. The inner tube 10 extends partly in the outer tube 20. It also includes a nut 70 comprised of a succession of cams 40, 50 and 60 of cylindrical general shapes.

The linear actuator shown in FIG. 12 includes, in addition, a third tube 300 the diameter of which is larger than that of the outer tube 20. The outer tube extends partly in the third tube 300. The nut 370 is rigidly connected to the outer tube 20, so that the outer tube 20 is capable of rotating a nut 370 including cams 340 and 350.

The tubes 10 and 300 are locked in rotation with respect to each other and are capable of being driven to slide with respect to each other in their longitudinal direction. The outer tube 20 is mounted floating, i.e. it is locked in rotation neither with respect to the inner tube 10 nor with respect to the third tube 300.

When the motor 2 of the actuator of FIG. 12 is operating, it rotates the nut 70 including the cams 40, 50 and 60. The balls 22 then roll between their ball-race and the inner surface of the intermediate tube 20. Since the tubes 10 and 300 are locked in rotation with respect to each other, the rotation of the nut 70 causes the inner tube 10 to be displaced in translation with respect to the unit formed of the outer tube 20 and the third tube 300. This translation is limited by a thrust.

When the inner 10 and outer 20 tubes are in abutment against each other, the tubes 10 and 20 are then rotated simultaneously. The outer tube 20 then rotates the nut 370 including the cams 340 and 350. The balls 22 then roll between their ball-race formed by the cams 340 and 350 and the inner surface of the third tube 300. Since the tubes 10 and 300 are locked in rotation with respect to each other, the rotation of the nut 370 causes the unit comprised of the inner tube 10 and the outer tube 20 to be moved in translation with respect to the third tube 300.

This results into the thus produced telescopic actuator unfolding in two steps. In a first step, the inner tube 10 is displaced in translation with respect to the outer tube 20 and to the third tube 300, then, in a second step, the inner 10 and outer 20 tubes are displaced in translation with respect to the third tube 300. This unfolding in two steps is due to the fact that the couple necessary to rotate the nut 370 with respect to the third tube is larger than the couple necessary to rotate the nut 70 with respect to the outer tube.

The unfolding can also occur at random depending on the friction torques occurring in the mechanism.

Such a telescopic actuator has the advantage of being able to reach larger unfolding lengths than with a simple actuator as shown in FIG. 1.

In the actuator shown in FIG. 12, the nut 70 includes two pairs of cams and the nut 370 includes only one pair of cams. Of course, it is possible to manufacture telescopic actuators having a larger number of tubes and a different number of cams. FIG. 13 shows the actuator of FIG. 12 in unfolded position.

The tubes 20 and 300 each have ball-races on their inner surfaces. These races preferably have the same pitch. Thus, the unfolding of the actuator will occur at a constant speed. In addition, it will be possible, by counting the number of revolutions of the motor, to know the exact position of the actuator.

If the races of the tubes 20 and 300 have different pitches, the unfolding speed of the actuator will vary according to the tube which will be moving at a given moment.

Generally, in a telescopic actuator including a plurality of tubes capable of being driven in translation with respect to each other, one can choose to establish different race pitches for the various tubes. One thus obtains a telescopic actuator which sequentially unfolds with programmable values of motor/movement reduction coefficient over the total travel distance of the actuator. This feature allows to adapt the evolution of the motor torque provided depending on the profile of the load the actuator has been subjected to during its unfolding, this profile being determined length by length.

If one wants the tubes to unfold in a given order, it is possible to add means for braking the rotation of the tubes with respect to each other (for example one or several O-ring(s) rubbing against the tubes, so that the latter unfold sequentially.

The preceding description relates to an example of linear actuator in which the means for driving the nut include an electric motor 2. It will be understood that it is of course possible to use other types of driving means: hydraulic motor or the like.

Now it will described more in detail the passing over of a ball from one ball-race to the next one in the case of an actuator including an outer tube the inner surface 20 of which has ball-races.

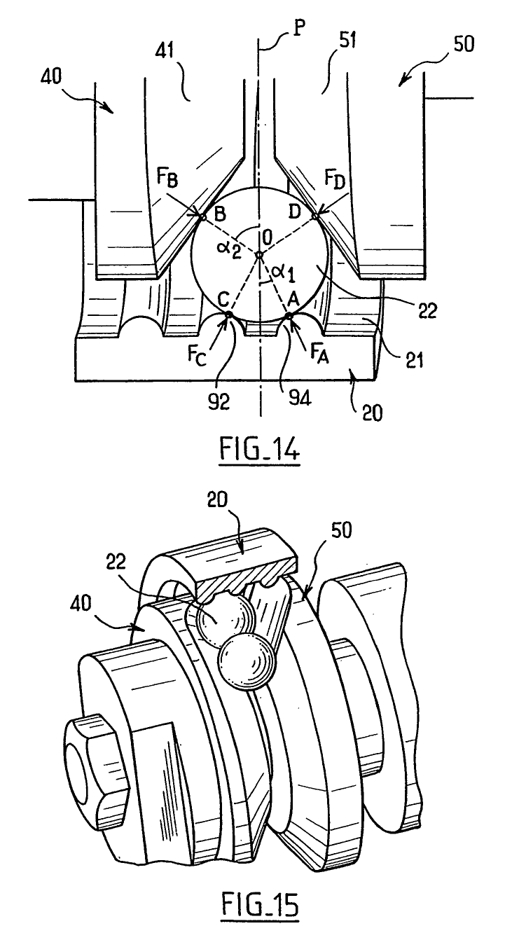

FIG. 14 shows a ball 22 with a center 0 maintained between the beveled surfaces 41 and 51 of the cams 40 and 50 and a ball-race formed, for example, by two wires 92 and 94. The points of contact between the ball 22 and the cam 40, the cam 50, the wire 92 and the wire 94, are designated by B, D, C and A, respectively. The angle between the plane P with a straight cross-section of the actuator passing through 0 and the straight line (OA) are designated by α₁ and the angle between the plane P and the straight line (OB) is designated by α₂. The forces exerted on the ball by the cams and the ball-race are designated by F_{A}, F_{B}, F_{C} and F_{D}.

If α₁=α₂, we have F_{A}=F_{B}, so that the ball is in balance and the forces F_{C} and F_{D} are zero.

If α₁>α₂, we have F_{A}+F_{B}+F_{C}=0 and the force F_{D} exerted by the cam 50 is zero.

If α₁<α₂, we have F_{A}+F_{B}+F_{D}=0 and the force F_{C} exerted by the cam 40 is zero.

The cams 40 and 50 are rotated so that the ball 22 arrives at a widened re-circulation zone as shown in FIG. 15. From that moment on, the ball 22 is no longer into contact with the cam 50, so that it is no longer balanced, since no force applies at D. The ball 22 is subjected to a force imparting it an acceleration allowing it to separate from the ball-race and to cross the wire 94, in order to position itself on the adjacent race.

The passing over of the ball 22 from one race to the next one can occur only if α₁<α₂, so that the resultant of the forces on the ball passes over the wire 94.

In addition, if one takes into consideration the frictions which are exerted on the ball 22 and which are designated by φ₁ and φ₂, the friction angles between the ball and the wire 94 and between the ball and the cam 40, a condition for the passing over of the ball from one race to the next one to occur is: α₁+φ₁+φ₂<α₂. When assuming by φ₁ and φ₂ in the range of 5 degrees (lubricated contact), and α₁ in the range of 35 to 45 degrees, one deduces therefrom that α₂ must be of more than 45 or 55 degrees.

In order to facilitate the passing of balls from one race to another and to maintain a good efficiency, α₂ can be chosen between 50 and 60 degrees, preferably to be 55 degrees. When α₂ is in the range of 55 degrees, the cam 40 has a helical beveled surface 41 oriented at 35 degrees with respect to the plane P. A cam having such a helical bevel can be achieved by machining a cylindrical part with a conical cutter having at the top half an angle of 55 degrees.

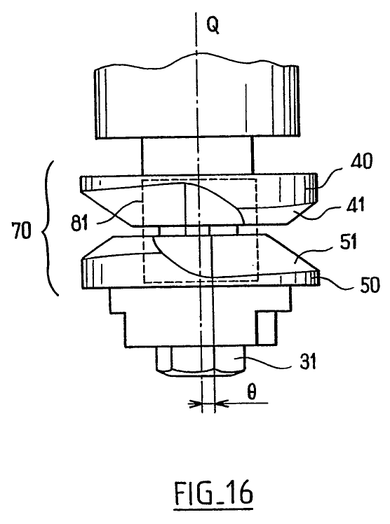

Furthermore, FIG. 16 shows the positioning of two cams 40 and 50 with respect to each other. The plane Q extends transversely to the plane of the diagram and passes through the axis of rotation of the nut 70 including both cams 40 and 50. The cams 40 and 50 are identical. They are arranged in front of each other, so that the rolling surfaces 41 and 51 face each other. The cams are indexed by their key slots (see FIG. 5), the key slots extending in the plane Q. As shown in FIG. 16, the key slots are positioned so as to form an angle θ with respect to the reference mark formed by an end of the helical surface corresponding to the leading plane of the cutter.

The angle θ can be set in order to minimize the space of evolving of the balls in the re-circulation zone 81, in order to avoid the presence of several balls at the same time in this zone and to keep the largest possible number of “working” balls. The setting of the angle θ depends namely on the pitch of the ball-race, on the orientation of cam surfaces 41 and 51, on the diameter of the balls 22, on the diameter of the wires 92 and 94 used for making the races.

A way for determining this angle θ consists in determining the volumes in which the center O of a ball moves when the latter is resting against one of the cam surfaces, resting on the other cam surface and resting on the ball-races, respectively. The intersection of these volumes represents the space in which the ball is guided. This space can be modified by varying the angle θ. The space of intersection must both be large enough for a ball to be able to enter into the re-circulation zone and to move on the helical ball-race and sufficiently restricted to prevent several balls from being present simultaneously in the re-circulation zone 81. The shape of the space obtained depends on angle θ and also on the shape of the setback surfaces of the cams.

1. Actuator comprising:
a first tubular body,
a nut positioned inside the tubular body and having at least a generally helical ball-race with a helical portion extending about the nut according to an angle of less than 360 degrees and a widened portion connecting the ends of the helical portion, said widened portion forming a re-circulation zone for balls arranged between the ball-race and the inner surface of the tubular body, and
a driving means for rotating the nut, in order to ensure displacement in translation of the tubular body with respect to the nut, wherein the inner face of the first tubular body comprises helical ball-races for guiding the balls.

2. Actuator according to claim 1, wherein the inner surface of the first tubular body has a helical pitch substantially equal to the helical pitch of a ball-race of the nut.

3. Actuator according to claim 1, wherein said nut comprises several ball-races, each ball-races having a re-circulation zone for the balls and in that the ball-races are so arranged that the re-circulation zones for the balls are not aligned in a direction of translation of the actuator.

4. Actuator according to claim 3, wherein the ball-races are so arranged that the re-circulation zones are regularly angularly distributed about the direction of translation of the actuator.

5. Actuator according to claim 1, wherein said nut comprises several aligned elements, of a cylindrical general shape, each element having at least one bevel forming a helical cam surface, the bevels forming, two by two, helical ball-races in which balls are positioned.

6. Actuator according to claim 5, wherein each helical cam surface forms a setback, and wherein two elements are so positioned with respect to each other that their setbacks are facing each other, said setbacks forming the re-circulation zone for the balls.

7. Actuator according to claim 5, wherein prestressing exerted on the balls is generated by tightening the elements with respect to each other.

8. Actuator according to claim 7, further comprising: another nut for adjusting the elements, in order to control the prestressing exerted on the balls.

9. Actuator according to claim 8, further comprising: a springy means interposed between the adjusting nut and the elements of the nut, through which the adjusting nut exerts a prestressing on the elements.

10. Actuator according to claim 3, wherein each element is comprised of a cylindrical part with a straight cross-section, one circular edge thereof being beveled and forming said helical cam surface inclined with respect to the axis of the cylindrical part, the ends of the helical surface being connected by a setback surface 5 of a conical general shape.

11. Actuator according to claim 10, wherein the ball-race is comprised of a widened re-circulation zone for the balls defined by the setback surfaces of two elements, the setback surfaces being positioned in front of each other, in an opposite way.

12. Actuator according to claim 1, wherein said driving means comprises a motor mounted fixed inside a second tubular body, being drivable in translation with respect to the first tubular body.

13. Actuator according to claim 1, wherein the ball-races at the level of the inner surface of the tubular body are comprised of plastic distortion of the inner surface by the balls, followed by a treatment for hardening this inner surface of the tubular body.

14. Actuator according to claim 1, wherein the ball-races at the level of the inner surface of the first tubular body are comprised of at least one wire positioned in the shape of a spiral inside the first tubular body.

15. Actuator according to claim 14, further comprising: a first wire positioned in the shape of a spiral inside the first tubular body, on which the balls rest, and a second intercalated wire having a diameter smaller than that of the first wire and extending between the windings of the first wire, said second wire maintaining the separation between the windings of the first wire.

16. Actuator according to claim 1, further comprising: an inner tube arranged in the tubular body and welded to the tubular body, the inner tube having ball-races carried out by burnishing.

17. Actuator according to claim 1, further comprising: a third tubular body, the first tubular body being connected to a second nut, rotation of the second nut causing the displacement in translation of the third body with respect to the first tubular body, the actuator thus constituting an actuator of the telescopic type.

18. Actuator according to claim 1, wherein the first tubular body is comprised of aluminum, KEVLAR©, carbon fibers or molded plastic.
